(19) United States
(12) Patent Application Publication
(10) Pub. No.: US 2014/0370782 A1
(43) Pub. Date: Dec. 18, 2014

(54) Insect Moat for Bee Hive Stand Legs

(71) Applicant: Jeffrey Mitchell Barton, San Jose, CA (US)

(72) Inventor: Jeffrey Mitchell Barton, San Jose, CA (US)

(21) Appl. No.: 14/151,314

(22) Filed: Jan. 9, 2014

Related U.S. Application Data
(60) Provisional application No. 61/835,075, filed on Jun. 14, 2013.

(51) Int. Cl. A01K 47/06

(52) U.S. Cl. CPC A01K 47/06
USPC 449/50

(57) ABSTRACT

An insect moat for bee hive stand legs has a base and a lid. An outer moat wall encloses an inner moat wall on a bottom plate, forming a moat between the inner and outer moat walls within which an insect impeding substance can be places. The inner moat wall encloses a leg chamber. A lid is removably engaged atop the base, and occludes any vertical passage into the moat, preventing rainwater, debris or stray bees from getting into the moat. A leg of a bee hive stand or other outdoor furniture is placed within a leg chamber of the base defined as within the inner moat wall, traversing through an opening in the lid, thereby being protected from the advance of ants or other crawling insects up the stand leg. A plurality of holes traversing through the bottom plate allows any rainwater to drain from the leg chamber.

The current application claims a priority to the U.S. Provisional Patent application Ser. No. 61/835,075 filed on Jun. 14, 2013.

### FIELD OF THE INVENTION

The present invention relates generally to outdoor furniture. More specifically the present invention is an ant moat for bee hive stands.

### BACKGROUND OF THE INVENTION

Bees are flying insects related to wasps and ants, and are known for their role in pollination and for producing honey and beeswax. Bees are found on every continent except Antarctica, in every habitat on the planet that contains insect-pollinated flowering plants. Bees are adapted for feeding on nectar and pollen, the former primarily being an energy source and the latter primarily for protein and other nutrients. Most pollen is used as food for larvae. The best-known species of bee is the European honey bee, which produces honey. Human management of this species is known as beekeeping or apiculture. Beekeeping is a common practice typically motivated by research and/or harvesting of honey, honeycomb or other resources from beehives.

Bee hives are a popular attraction to insects due to the abundance of honey stored within. In beekeeping, bee hives are commonly stored within hutches or stands which are supported above the ground by several legs. A common problem with bee hive stands is that they enable insects such as ants the ability to reach the hive since the bee hive stand is mounted into the ground. This is undesirable as it can result in disruption of the bee colony. It is therefore an object of the present invention to introduce an ant moat for bee hive stands that prevents ants from scaling the legs of the bee hive stand and reaching the bee hive.

### BRIEF DESCRIPTION OF THE DRAWINGS

FIG. 1 is a perspective view of the present invention.

FIG. 2 is a side view of the present invention.

FIG. 3 is a perspective view of the base.

FIG. 4 is a side cross sectional view of the base.

FIG. 5 is a perspective view of the present invention being used with a stand leg.

FIG. 6 is a side cross sectional view of the present invention being used with a stand leg.

FIG. 7 is a perspective view of the lid.

FIG. 8 is a bottom view of the lid.

FIG. 9 is a side cross sectional view of the lid.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is an insect moat primarily intended for use with the legs of a bee hive stand. The present invention provides a moat or trench around each leg of the bee hive, preventing ants and other insects from accessing the bee hive and stealing honey from the hive. It should be noted that the words “moat” and “trench” have the same meaning in relation to the present invention. It should be noted that while the inspiration for the present invention is to protect the honey within bee hives from foraging ants, the present invention may be utilized with other types of outdoor furniture or apparatuses, such as, but not limited to, any type of table, bench or other piece of furniture which could benefit from being isolated from ants and other crawling insects.

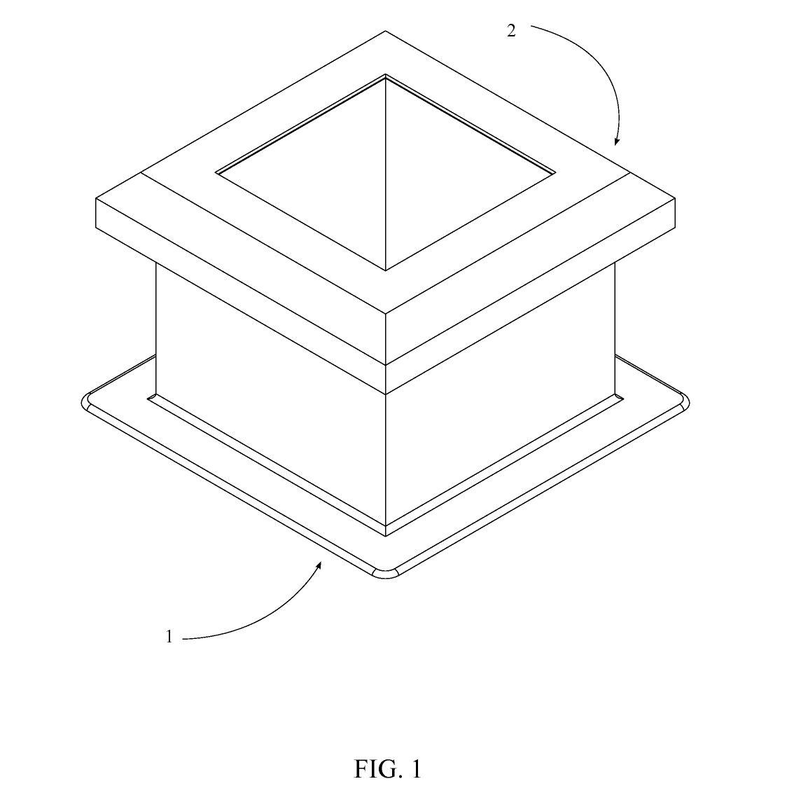

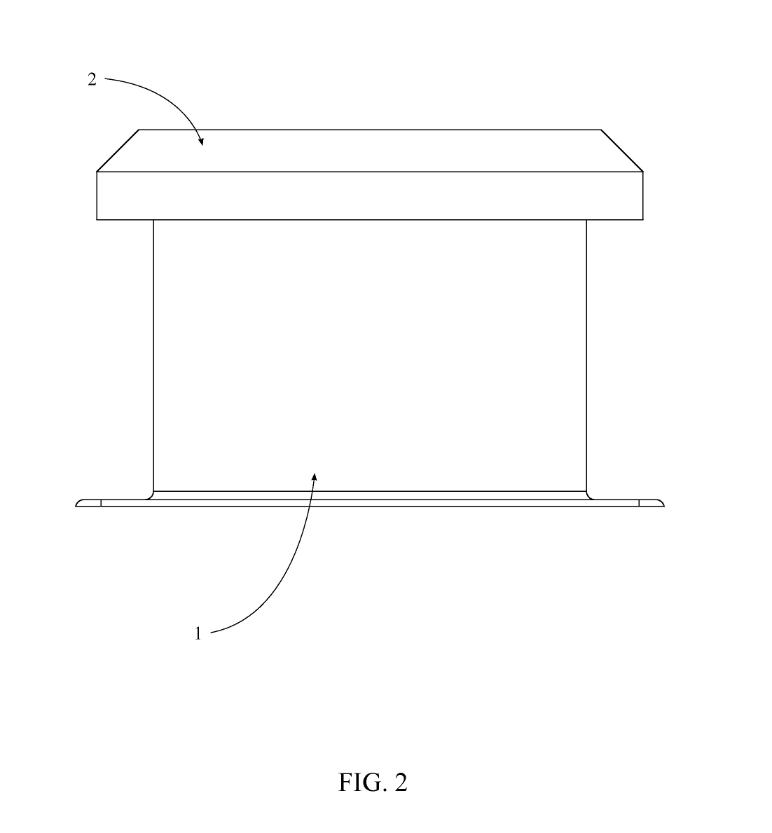

Referring to FIGS. 1-2, the present invention generally comprises a base 1 and a lid 2. The base 1 is the primary component of the present invention within which a stand leg 3 of a beehive stand or other apparatus rests and contains a moat 14 which impedes the progress of ants or other crawling insects. The lid 2 is removably engaged atop the base 1, and serves to provide additional impediment to crawling insects and prevent bees from falling into the moat 14 and becoming trapped. In the preferred embodiment of the present invention, the base 1 and the lid 2 are each made from a durable plastic material with ultraviolet radiation resistance properties, and other properties which are conducive to long-term outdoor use. However, the material the present invention is made of does not significantly change the functionality of the present invention and should not to be a limiting factor.

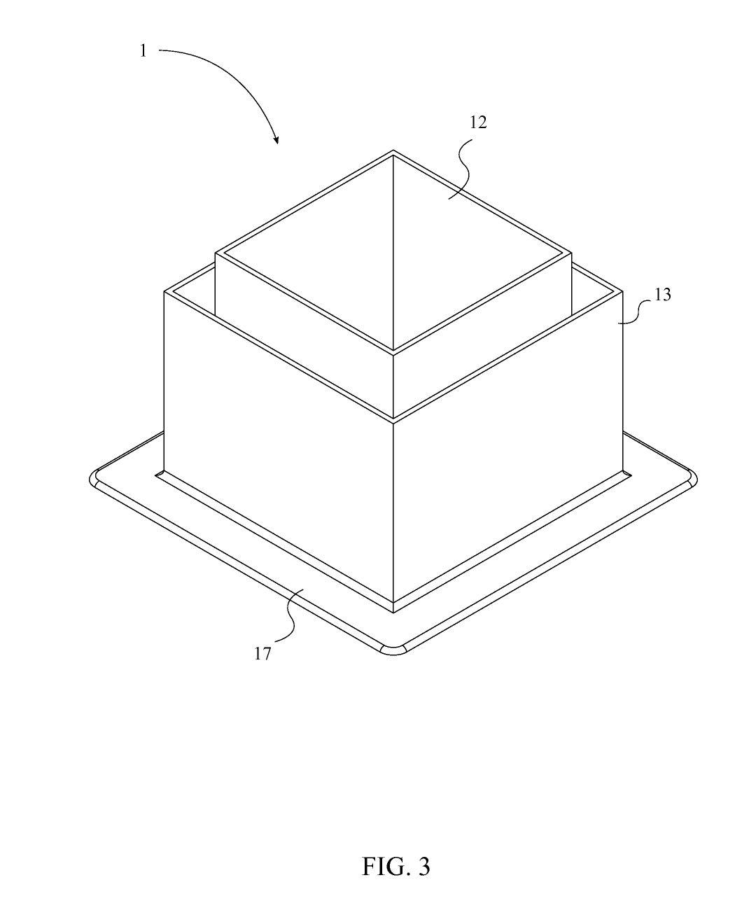

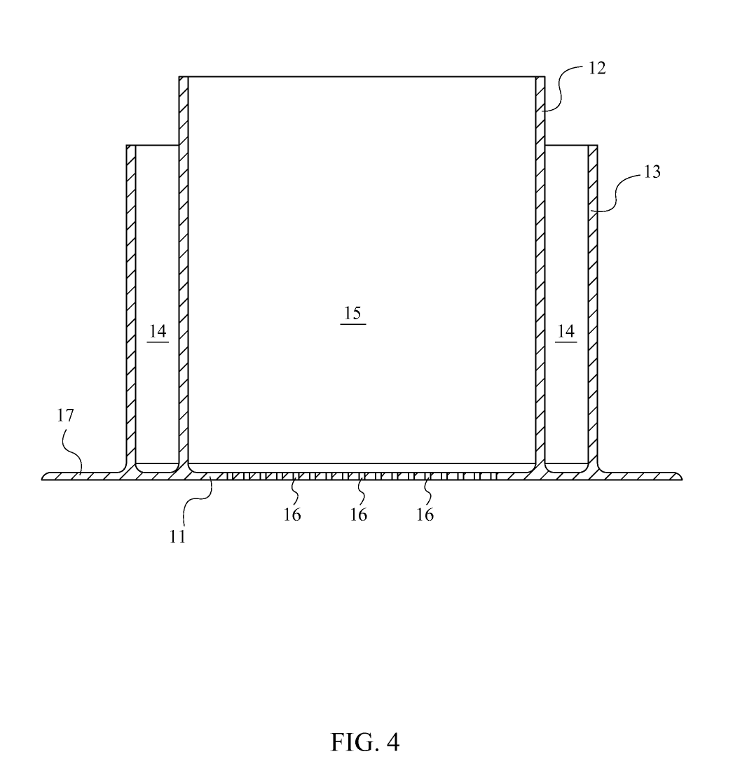

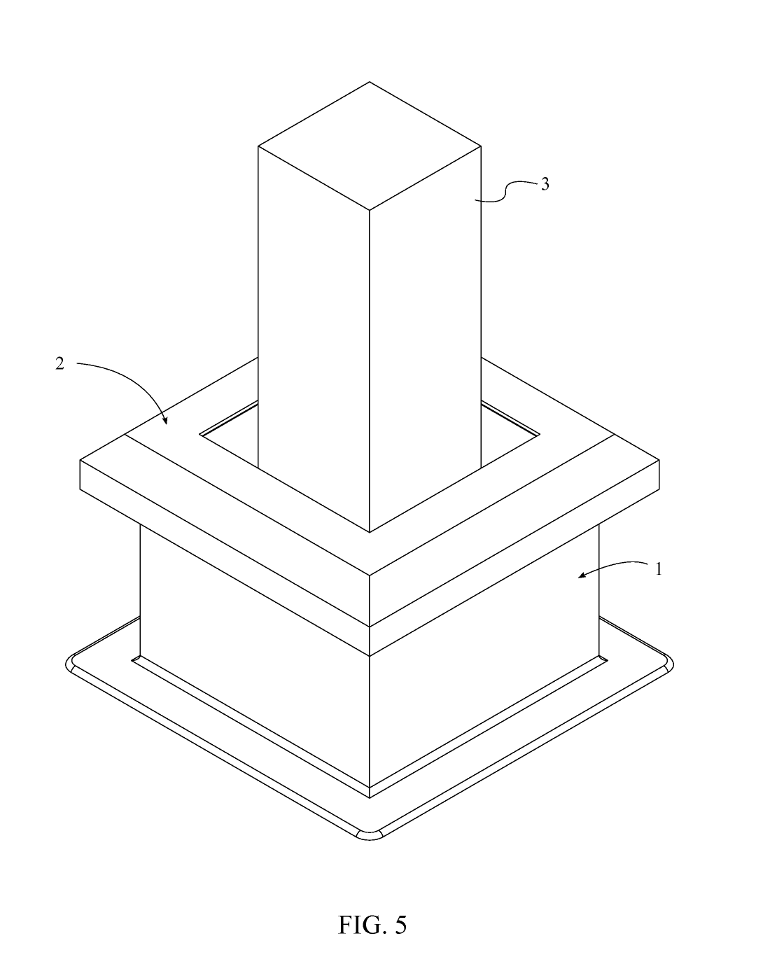

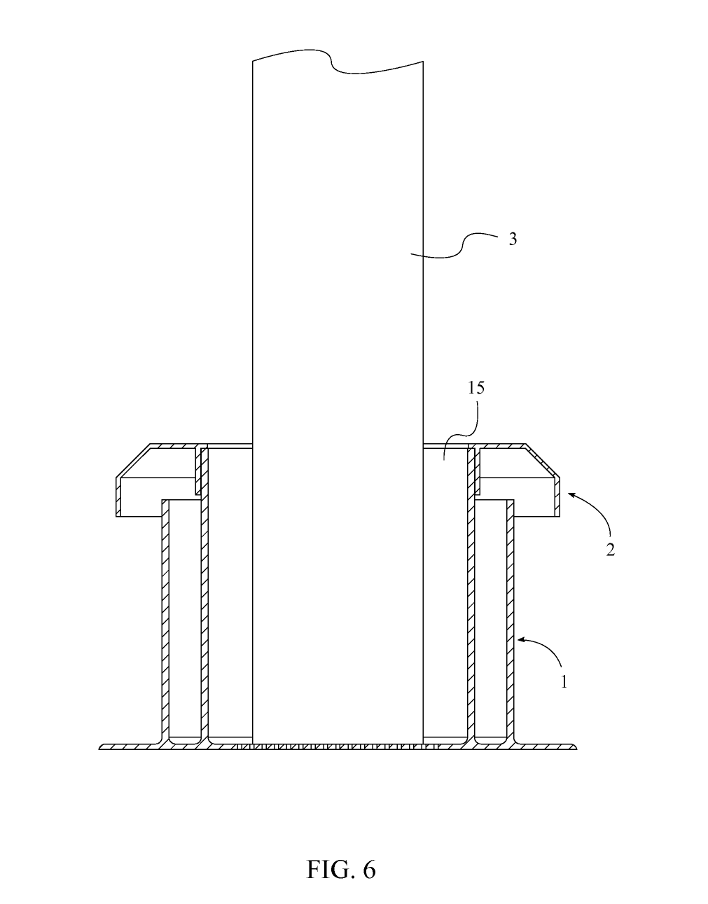

Referring to FIGS. 2-4, in the preferred embodiment of the present invention, the base 1 comprises a bottom plate 11, an inner moat wall 12, and an outer moat wall 13. The bottom plate 11 is a flat plate-like body which rests on the ground and supports the rest of the present invention. The inner moat wall 12 and the outer moat wall 13 are connected to the bottom plate 11, and are oriented perpendicular to the bottom plate 11. The inner moat wall 12 and the outer moat wall 13 extend upwards from the bottom plate 11, wherein the bottom plate 11 rests on the ground while in use. The outer moat wall 13 encloses the inner moat wall 12, forming a moat 14 between the inner moat wall 12 and the outer moat wall 13. The inner moat wall 12 is taller than the outer moat wall 13, wherein the inner moat wall 12 extends farther away from the bottom plate 11 than the outer moat wall 13. The inner moat wall 12 encloses a leg chamber 15, wherein the stand leg 3 is placed within the leg chamber 15 when the present invention is in use, as shown in FIGS. 5-6.

When in use, the leg of a bee hive stand or other stand-like apparatus is placed within the inner moat wall 12. To impede ants or other crawling insects from accessing the stand leg 3, the moat 14 is partially or completely filled with a substance that thwarts the ants from traversing from outside the moat 14 into the leg chamber 15. Any such insect impeding substance may be used as appropriate or useful, such as, but not limited to, water, oil, alcohol, baking soda, ground cinnamon, diatomaceous earth, or another substance which prevents ants or other crawling insects from traversing the moat 14.

The inner moat wall 12 and the outer moat wall 13 each have closed geometry in order to properly contain the insect impeding substance and ensure full coverage of the moat 14 around the stand leg 3. In the preferred embodiment of the present invention, the bottom plate 11, the inner moat wall 12 and the outer moat wall 13 are square or rectangular, but it is contemplated that alternate embodiments may comprise alternate geometries for the present invention such as, but not limited to, circular or triangular without affecting the functionality of the present invention.

In the preferred embodiment of the present invention, a plurality of holes 16 traverses through the bottom plate 11. The inner moat wall 12 encloses the plurality of holes 16. The purpose of the plurality of holes 16 is to drain any rainwater accumulation within the leg chamber 15 to prevent rusting of metal legs or rotting of wooden legs due to buildup of rainwater within the leg chamber 15. Each of the plurality of holes 16 should be very small so as to not allow ants or other crawling insects into the leg chamber 15. Additionally, in the preferred embodiment the bottom plate 11 comprises a stabilizing flange 17. The stabilizing flange 17 is simply a portion of the bottom plate 11 that extends laterally outwards from the outer moat wall 13. The stabilizing flange 17 functions to provide stability against rocking side to side and is positioned perimetrically adjacent to the outer moat wall 13 opposite the moat 14. Additionally, the stabilizing flange 17 prevents grass or weeds from growing close to the inner moat wall 12 and providing insects with a bridge for traversing the moat 14.

While the base 1 is the primary feature of the present invention, several problems are presented by using the base 1 alone for the purpose of providing a moat 14 which blocks ants from accessing the leg of a bee hive stand. Rainwater may collect within the moat 14, filling the moat 14, diluting the insect impeding substance and possibly negating the impeding effects of the insect impeding substance, allowing insects to traverse the moat 14 and access the stand leg 3. Similarly, debris may fall within the moat 14, providing insects with the means to traverse the moat 14. Another problem with using only the base 1 is presented in the context of using the present invention to prevent ants from accessing a bee hive stand. This problem is that bees are not particularly adept at flying, and without a lid 2 to cover the moat 14 bees may accidentally stray or fall into the moat 14, become trapped and die. Clearly this is a detriment to any bee keeper and is desirable to prevent. Therefore, the lid 2 should be used in conjunction with the base 1 in order to cover the moat 14.

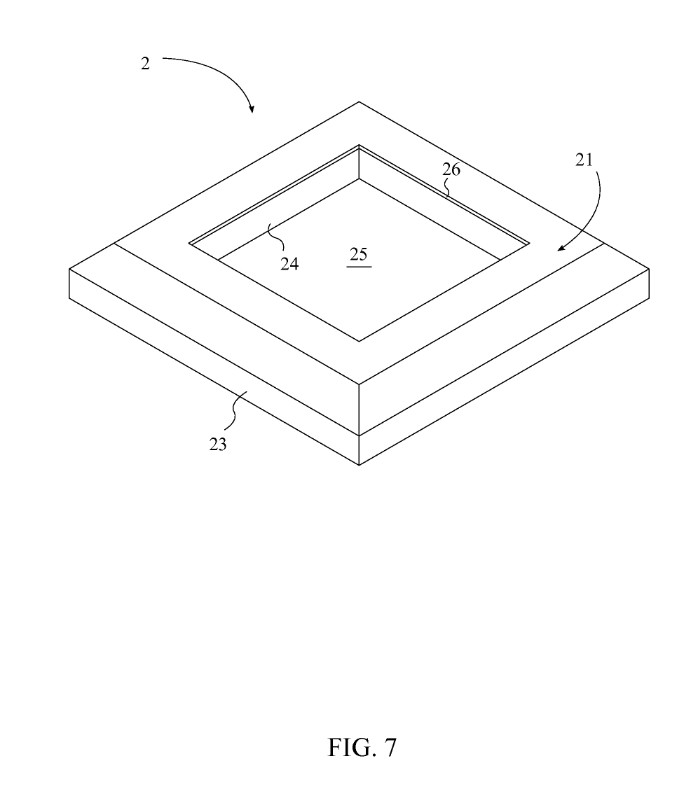

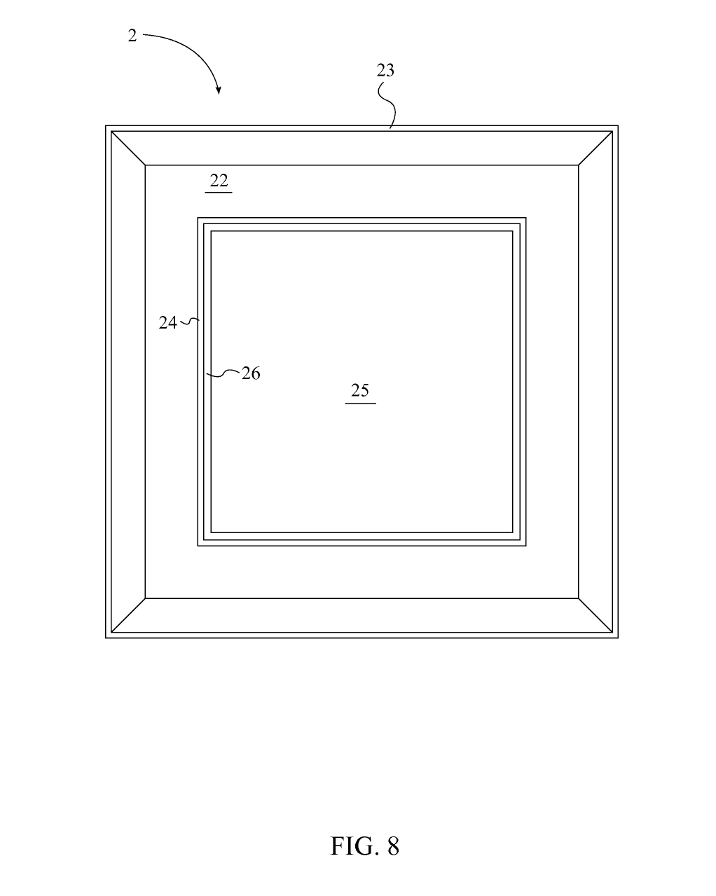

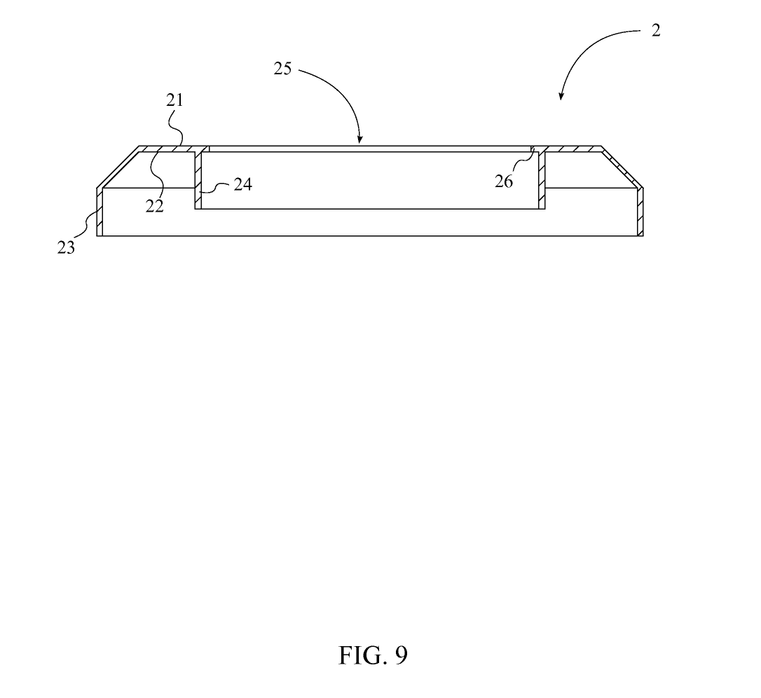

Referring to FIGS. 7-9, in the preferred embodiment of the present invention, the lid 2 comprises an upper surface 21, a lower surface 22, an opening 25, an eave 23, and an engagement guide wall 24. The opening 25 traverses through the lid 2; more particularly, in the preferred embodiment the opening 25 is centrally positioned on the lid 2 so that the opening 25 centrally traverses through the lid 2, though the position, shape and dimensions of the opening 25 on the lid 2 are primarily aesthetic features and not of particular importance to the function of the present invention, so long as the stand leg 3 is able to traverse through the lid 2 and rest within the leg chamber 15. The upper surface 21 and the lower surface 22 are positioned opposite each other on the lid 2. The lid 2 should have larger outer dimensions than the outer moat wall 13 to provide adequate coverage from rain, debris and bees or other flying insects.

The eave 23 is an overhang with closed geometry perimetrically connected around the lid 2 in order to prevent bees from finding their way into the moat 14 and becoming trapped and drowning. In the preferred embodiment, the eave 23 is connected to the lower surface 22, oriented perpendicular to the lower surface 22, and positioned around the opening 25. When the lid 2 is engaged with the base 1, the outer moat wall 13 is enclosed by the eave 23. Alternatively stated, when the lid 2 is engaged with the base 1, the outer moat wall 13 is positioned between the eave 23 and the inner moat wall 12. In one example embodiment, when the lid 2 is engaged with the base 1, the eave 23 and the outer moat wall 13 are separated by a horizontal distance of ½ inch. However, dimensions are not of particular importance to the present invention beyond the capability of the opening 25 to accept the leg stand 3, and for the lid 2 to properly fit onto the base 1 and provide adequate coverage of the moat 14.

The engagement guide wall 24 is a wall with closed geometry connected to the lower surface 22 that facilitates proper engagement between the lid 2 and the base 1. Preferably, the engagement guide wall 24 is dimensioned slightly larger than the inner moat wall 12, so that the engagement guide wall 24 fits snugly around the inner moat wall 12 when the lid 2 is engaged with the base 1, as can be seen in FIG. 6. The engagement guide wall 24 is connected to the lower surface 22 and is preferably oriented perpendicular to the lower surface 22. The engagement guide wall 24 is positioned around the opening 25, and is positioned between the opening 25 and the eave 23. The engagement guide wall 24 is positioned near the opening 25, but not abutting against the opening 25. This leaves a small portion of the lid 2 to form a lid support flange 26 that is perimetrically positioned between the engagement wall and the opening 25.

As shown in FIG. 6, when the lid 2 is engaged with the base 1, the lower surface 22 of the lid 2 rests on the base 1. More particularly, in the preferred embodiment the lower surface 22 of the lid 2 rests atop the inner moat wall 12 opposite the bottom plate 11 when the lid 2 is engaged with the base 1. Even more particularly, the lid support flange 26 of the lid 2 rests atop the inner moat wall 12 when the lid 2 is engaged with the base 1.

Although the invention has been explained in relation to its preferred embodiment, it is to be understood that many other possible modifications and variations can be made without departing from the spirit and scope of the invention as hereinafter claimed.

What is claimed is:

1. An insect moat for bee hive stand legs comprises:
a base;
a lid;
the lid being removably engaged with the base;
the base comprises a bottom plate, an inner moat wall, and an outer moat wall;
the lid comprises an upper surface and a lower surface, an opening, and an eave;
the inner moat wall and the outer moat wall being connected to the bottom plate;
the outer moat wall enclosing the inner moat wall, wherein a moat is formed between the inner moat wall and the outer moat wall;
the eave being connected to the lower surface; and
the eave being positioned around the opening.

2. The insect moat for bee hive stand legs as claimed in claim 1 comprises:
the lid resting atop the inner moat wall opposite the bottom plate when the lid is engaged with the base.

3. The insect moat for bee hive stand legs as claimed in claim 1 comprises:
the inner moat wall and the outer moat wall each having closed geometry.

4. The insect moat for bee hive stand legs as claimed in claim 1 comprises:
the inner moat wall and the outer moat wall each being oriented perpendicular to the bottom plate.

5. The insect moat for bee hive stand legs as claimed in claim 1 comprises:
the inner moat wall being taller than the outer moat wall, wherein the inner moat wall extends farther away from the bottom plate than the outer moat wall.

6. The insect moat for bee hive stand legs as claimed in claim 1 comprises:
a plurality of holes traversing through the bottom plate.

7. The insect moat for bee hive stand legs as claimed in claim 6 comprises:
the inner moat wall enclosing the plurality of holes.

8. The insect moat for bee hive stand legs as claimed in claim 1 comprises:
the bottom plate comprises a stabilizing flange; and
the stabilizing flange being positioned perimetrically adjacent to the outer moat wall opposite the moat.

9. The insect moat for bee hive stand legs as claimed in claim 1 comprises:
the opening traversing through the lid.

10. The insect moat for bee hive stand legs as claimed in claim 9 comprises:
the opening being centrally positioned on the lid.

11. The insect moat for bee hive stand legs as claimed in claim 1 comprises:
the upper surface and the lower surface being positioned opposite each other on the lid.

12. The insect moat for bee hive stand legs as claimed in claim 1 comprises:
the eave being oriented perpendicular to the lower surface.

13. The insect moat for bee hive stand legs as claimed in claim 1 comprises:
the eave being perimetrically connected around the lid.

14. The insect moat for bee hive stand legs as claimed in claim 1 comprises:
the outer moat wall being enclosed by the eave when the lid is engaged with the base.

15. The insect moat for bee hive stand legs as claimed in claim 1 comprises:
the lid further comprises an engagement guide wall.

16. The insect moat for bee hive stand legs as claimed in claim 15 comprises:
the engagement guide wall being connected to the lower surface.

17. The insect moat for bee hive stand legs as claimed in claim 15 comprises:
the engagement guide wall being oriented perpendicular to the lower surface.

18. The insect moat for bee hive stand legs as claimed in claim 15 comprises:
the engagement guide wall being positioned around the opening.

19. The insect moat for bee hive stand legs as claimed in claim 15 comprises:
the engagement guide wall being positioned between the opening and the eave.

20. The insect moat for bee hive stand legs as claimed in claim 1 comprises:
a lid support flange being positioned between an engagement guide wall of the lid and the opening, wherein the lid support flange rests atop the inner moat wall when the lid is engaged with the base.
